(19) United States
(12) Patent Application Publication
(10) Pub. No.: US 2009/0216380 A1
(43) Pub. Date: Aug. 27, 2009

(54) Adaptive algorithm for setting the proportional integral (pi) gains in lag-dominated hvacr systems

(75) Inventor: Richard A. Kolk, Anchorage, KY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 11/918,531

(22) PCT Filed: Apr. 14, 2005
(86) PCT No.: PCT/US2005/012582

§ 371 Date: Jan. 30, 2009

(51) Int. Cl. G05D 23/00

(52) U.S. Cl. 700/277; 700/41; 700/29; 700/276

(57) ABSTRACT

A method to determine and apply PI gain constants to an HVAC PI controller used to control an HVAC component includes the steps of: recording an opened loop HVAC component dynamic step response; fitting the HVAC component dynamic response to a transfer function model; calculating the PI gain constants from the model; entering the calculated PI gains into a PI control algorithm; and running the PI control algorithm on the HVAC PI controller to control the HVAC component. The inventive method can be used with an HVAC system comprising, an HVAC system component; an HVAC system component controller electrically connected to the HVAC system component to control the operation of the HVAC system component; and a PI algorithm. The PI algorithm uses PI gain constants calculated from the open loop transfer function of the HVAC system component.

### FIELD OF THE INVENTION

This invention relates generally to calculating and setting PI gain parameters and more particularly to a system and method to calculate PI gains in lag-dominated HVACR systems.

### BACKGROUND OF THE INVENTION

Heating, ventilation, air conditioning and refrigeration (“HVAC” or “HVACR”) systems typically control environmental factors such as temperature, pressure, and humidity. Zone controllers and bypass controllers are two components that can be used in HVAC systems. Zone controllers and bypass controllers typically control dampers, the dampers regulating air flow into air ducts. A zone controller can be used to control the temperature and ventilation requirements in one or more specific building spaces known as a “zone”. The zone controller performs this function by operating one or more zone dampers to control the flow of heating or cooling air into individual building zones. A bypass controller can then be used to adjust a bypass damper to compensate for the fluctuations in the supply air pressure caused by the operation of the various zone dampers throughout the HVAC system.

Both zone and bypass controllers can be microcomputer based controllers running control algorithms. Typically these control algorithms function as Proportional-Integral (“PI”) control loop algorithms. A PI algorithm controls a system component (also called the “plant”) to cause a desired effect by controlling the component in reaction to a feedback signal from one or more sensors. For example, a PI zone controller can cause the temperature in a controlled zone to reach a particular set point temperature based on a feedback signal from one or more temperature sensors located in the zone. For a given HVAC installation to operate accurately and efficiently, various parameters of the PI control loops must be “tuned” towards optimal values.

Tuning refers to setting parameters of the PI loop for efficient and stable operation of the installed HVAC system. Tuning can be done experimentally by adjusting various PI parameters and then observing the resulting system performance, often over long periods of time. Or, some PI controllers can periodically or continuously automatically tune PI parameters with varying success during normal system operation. Often automatically or manually adjusted systems end up operating inefficiently because they operate with less then optimal PI parameter settings.

HVAC system efficiency is particularly a concern with respect to lag-dominated systems. A system is said to be lag-dominated where a response, such as a change in temperature in a zone, is measurably delayed from the time a control input is made at the system component or plant. For example, a delay occurs where the change in the temperature of the air flow at a vent in a particular zone of a building is delayed by the time it takes the heated or cooled air to actually travel from the controlled damper the vent in the controlled space. It can be particularly important to correctly set the proportional and the integral (“PI”) gains in lag-dominated systems to reduce the actuator wear caused by unnecessary oscillations

Therefore, there is a need for a method to determine and set a more optimal set of PI gains based on actual measurements of the performance of the installed HVAC components.

### SUMMARY OF THE INVENTION

A method to determine and apply PI gain settings to an HVAC PI controller when used on a lag dominated HVAC component includes the following steps: recording an opened loop HVAC component dynamic response; fitting the dynamic response to a transfer function model representative of a first order lag dominated process; calculating the PI gain constants from the model; entering the calculated PI gains into a PI control algorithm; and running the PI control algorithm on the HVAC PI controller to control the HVAC component.

The inventive method can be used with an HVAC system comprising, an HVAC system component; an HVAC system component controller electrically connected to the HVAC system component to control the operation of the HVAC system component; and a PI algorithm. The PI algorithm can run in the HVAC system component controller, the PI algorithm having PI gain constants, wherein the HVAC system component controller operates a closed PI loop. And, the PI algorithm uses PI gain constants calculated from the open loop transfer function of the HVAC system component.

### BRIEF DESCRIPTION OF THE DRAWINGS

For a further understanding of these and other objects of the invention, reference will be made to the following detailed description of the invention which is to be read in connection with the accompanying drawing, where:

FIG. 1 is a block diagram showing the steps of the method;

FIG. 2 is a block diagram of an exemplary HVAC system;

FIG. 3 shows a Root Locus behavior with spec point;

FIG. 4 shows a Root Locus diagram for the example; and

FIG. 5 is a computer simulation showing the exemplary system response.

It is to be understood that the drawings are for the purpose of illustrating the concepts of the invention and are not necessarily drawn to scale.

### DETAILED DESCRIPTION OF THE INVENTION

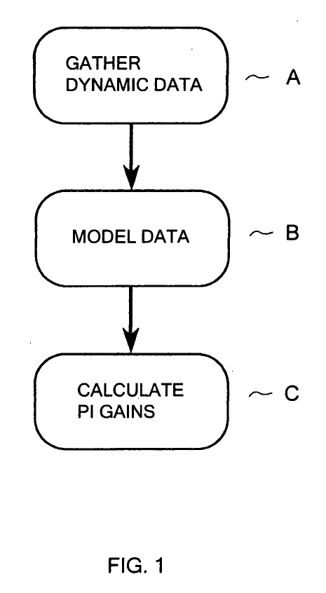

The steps of the method to determine the PI settings based on actual measurements of the performance of the installed HVAC components are shown in FIG. 1. In block A, dynamic data is gathered, while the equipment is in its commissioning phase. In this phase the actuator is swept over its full range to identify the high and low limits of position and the step response dynamics. Useful dynamic data includes time, valve position, and sensed temperature. In block B, The data is modeled using least square system identification (“LSID”) or a similar identification method. The data can generally be modeled as a first order transfer function with time delay. In block C, proportional-integral (PI) gain constants are calculated based on the model parameters and a desired damping ratio using the Root Locus method. While most installations can be modeled by first order transfer functions, it should be noted that the method can be extended to higher order functions.

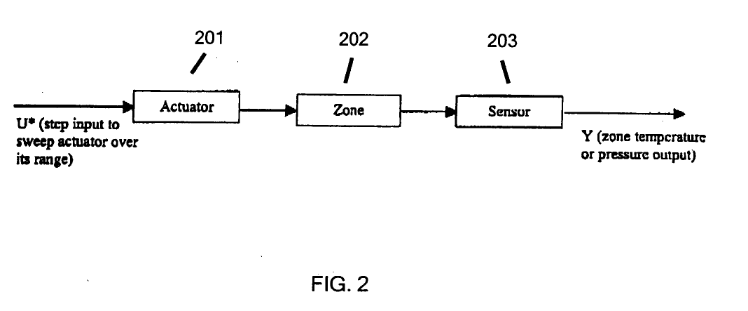

Gathering Dynamic Data: The method is now further explained using the exemplary HVAC zone controller shown in FIG. 2. Actuator 201 controls the airflow into zone 202. The resulting temperature or pressure in zone 202 is measured by sensor 203. A step input signal U* is applied to the input of actuator 201. The amplitude of the step is set so as to sweep actuator 201 over most or all of its useable range. Y represents the zone temperature or pressure as a function of time as measured by sensor 203 while actuator 201 is sweeping its range of movement.

Modeling the Dynamic Data: A first order transfer function model can be used to represent the dynamic data measured in the system of FIG. 2:

$$\frac{Y}{{U}^{⋆}} = \frac{K {e}^{- {st}_{d}}}{s + A}$$

where K,t_{d}, A can be approximated using Least Squares or a similar identification procedure.

Calculating the PI Gains: Calculation of the PI gains is now broken into three steps, approximation of the transcendental term with a transfer function model, solution of the transfer function parameters, and computation of the PI gains.

Removal of the Transcendental Term from the Transfer Function using a First Order Pade Approximation:

$$\frac{Y}{{U}^{⋆}} = \frac{K {e}^{- {st}_{d}}}{s + A} ≅ \frac{K ( - s + \frac{2}{{t}_{d}} )}{( s + \frac{2}{{t}_{d}} ) ( s + A )}$$

The Pade approximation as show above is known in the art. See for example: “Mechatronics System Design”, Shetty, D. & Kolk, R. PWS Publishing, division of International Thomson Publishing Company, 1997, pages 288-290, and “Feedback Control of Dynamic Systems”, Franklin, G., Powell, J. Emami-Naeini, Addison Wesley, pages 301.

Develop the PI Control Transfer Function:

$$PI - control = {K}_{p} + {K}_{i} s = \frac{{K}_{p} ( s + \frac{{K}_{i}}{{K}_{p}} )}{s} = \frac{{K}_{p} ( s + Z )}{s}$$

Compute the PI-control gains K_{P}, Kᵢ:

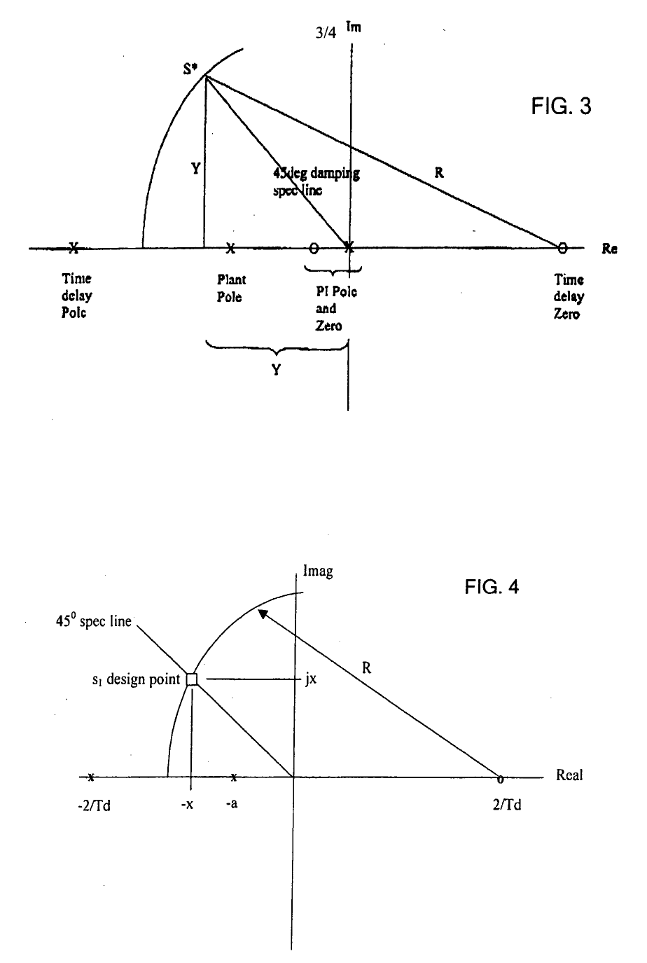

First select the PI-Zero, Z, to be located at 25% distance from the lowest frequency plant pole, −A as shown in the Root Locus diagram of FIG. 3. This criterial provides a good compromise between providing a fast response with minimal interaction with other poles and zeros in the system.

Z=0.25*A

The Root Locus diagram of FIG. 3 can then be used to determine the 45 degree (0.707 damping) specified operating point (“spec point”), S*, and to compute the required gain, K_{RL}, and then to compute the PI gains.

The Root Locus gain calculation is performed as follows;

The radius of the closed loop pole loci is estimated in terms of the plant pole and the time delay value as;

$$R = \frac{2}{{t}_{d}} + A + \frac{1}{2} ( \frac{2}{{t}_{d}} - A )$$

$${R}^{2} = {Y}^{2} + {( Y + \frac{2}{{t}_{d}} )}^{2}$$

Solving for Y; S*=−Y+jY

The Root Locus gain can then be calculated as:

$$\vert {K}_{RL} \vert ≅ \frac{\vert {S}^{⋆} + \frac{2}{{t}_{d}} \vert \cdot \vert {S}^{⋆} + A \vert}{K \cdot \vert {S}^{⋆} - \frac{2}{{t}_{d}} \vert}$$

Then, since the PI controller function is:

$$\frac{{K}_{p} ( s + Z )}{s} where z ≡ \frac{{K}_{p}}{{K}_{i}}$$

The gains are thus calculated as:

$${K}_{p} = {K}_{RL} and {K}_{i} = \frac{{K}_{p}}{Z}$$

### Example of the Adaptive PI Procedure:

Step 1: Collect step response time history data from the plant using the method described above in “Gathering Dynamic Data”. Data is collected and modeled by techniques well known in the art. For example, a step function stimulus can be applied to a damper controller set to operate in an open-loop mode. Several parameters can be recorded including the time of damper travel, initial air flow, and air flow as a function of time as the damper opens and reaches a steady state secondary position, which may or may not be full open. The inventive method is now illustrated using a model form generally useful for modeling lag-dominated HVAC systems.
Step 2: Fit data with a first order lag plus time delay model of the form; In this example the parameter a is used in place of A and b in place of K as originally introduced in 0018.

$$G ( s ) = {e}^{- {sT}_{d}} \frac{b}{s + a}$$

Step 3: The PI control transfer function is,

$$\begin{matrix}C ( s ) = {K}_{p} + \frac{{K}_{i}}{s} \\ = {K}_{p} \frac{s + \frac{{K}_{i}}{{K}_{p}}}{s} \\ = {K}_{p} \frac{s + z}{s}\end{matrix}$$

Select the PI zero, z, to be located

$$at \frac{1}{4} max ( - a , - \frac{2}{{T}_{d}} )$$

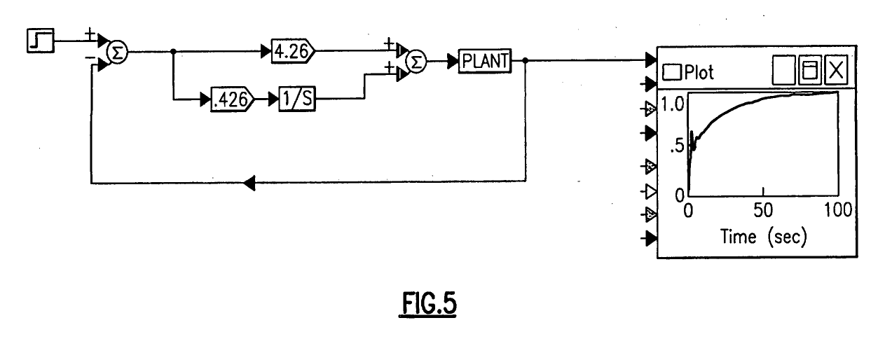

Step 4: Turning to the Root Locus plot of FIG. 4,
First calculate the Radius, R,

$$R = ( \frac{2}{{T}_{d}} + a ) + \frac{1}{2} ( \frac{2}{{T}_{d} } - a ) \\ = \frac{3}{{T}_{d}} + \frac{a}{2}$$

Next calculate the spec point coordinates for a damping of 0.707, −x+jx,

$$\begin{matrix}{R}^{2} = {x}^{2} + {( \frac{2}{{T}_{d} } - x )}^{2} \\ = {x}^{2} + \frac{4}{{T}_{d}^{2}} - \frac{4 x}{{T}_{d}} + {x}^{2} \\ = 2 {x}^{2} - \frac{4 x}{{T}_{d} } + \frac{4}{{T}_{d}^{2}} \\ 0 = 2 {x}^{2} - \frac{4 x}{{T}_{d} } + \frac{4}{{T}_{d}^{2}} - {R}^{2} \\ 0 = {x}^{2} - \frac{2 x}{{T}_{d}} + ( \frac{2}{{T}_{d}^{2}} - \frac{{R}^{2}}{2} ) \\ {x}_{1 , 2} = \frac{1}{{T}_{d}} \pm \frac{1}{2} \sqrt{2 {R}^{2} - \frac{4}{{T}_{d}^{2}}}\end{matrix}$$

Finally calculate the desired pole location, s₁=x+jx from the x value that obeys;

$$\frac{- 2}{{T}_{d}} < x < - a$$

Step 6: Calculate the proportional gain,

$${K}_{p} = \frac{\vert {s}_{1} \vert \vert {s}_{1} + a \vert \vert {s}_{1} + \frac{2}{{T}_{d}} \vert}{b \vert {s}_{1} + z \vert \vert {s}_{1} - \frac{2}{{T}_{d}} \vert}$$

Step 7: Calculate the integral gain, K₁=|z|.Kₚ

### Example starting from an exemplary plant transfer function:

Given—a hypothetical actual plant transfer function

$${G}_{plant} ( s ) = {( \frac{4}{s + 5} )}^{8}$$

Steps 1,2: The above plant exemplary plant, as hypothetically derived from an installed HVAC system, can be modeled by the first order plus time delay model,

$$G ( s ) = {e}^{- .76 s} \cdot \frac{1678}{s + 1} ,$$

where T_{d}=0.76, a=1, b=0.1678
Step 3: Select the PI zero as,

$$\begin{matrix}z = \frac{1}{4} max ( - a , - \frac{2}{{T}_{d}} ) \\ = \frac{1}{4} max ( - 1 , - 2.632 ) \\ = - .25\end{matrix}$$

### Step 4: Calculate the Root Locus Radius,

$$\begin{matrix}R = \frac{3}{{T}_{d}} + \frac{a}{2} \\ = \frac{3}{.76} + \frac{1}{2} \\ = 4.447\end{matrix}$$

Step 5: Calculate the desired pole locations to satisfy a damping ratio of 0.707. Calculate the real value of the pole as,

$${x}_{1 , 2} = \frac{1}{{T}_{d}} \pm \frac{1}{2} \sqrt{2 {R}^{2} - \frac{4}{{T}_{d}^{2}}}$$

$${x}_{1 , 2} = \frac{1}{.76} \pm \frac{1}{2} \sqrt{2 {( 4.447 )}^{2} - \frac{4}{{.76}^{2}}}$$

$${x}_{1 , 2} = - 1.54 , 4.172$$

The desired pole location, s₁=x+jx is based on the x value which obeys;

$$- \frac{2}{{T}_{d}} < x < - a$$

$${s}_{1} = - 1.54 + j 1.54$$

Step 6: Calculate the proportional gain,

$$\begin{matrix}{K}_{p} = \frac{\vert {s}_{1} \vert \vert {s}_{1} + a \vert \vert {s}_{1} + \frac{2}{{T}_{d}} \vert}{b \vert {s}_{1} + z \vert \vert {s}_{1} - \frac{2}{{T}_{d}} \vert} \\ = \frac{( 2.1779 ) ( 1.632 ) ( 1.888 )}{.1678 ( 4.447 ) ( 2.11 )} \\ = 4.26\end{matrix}$$

Step 7: Calculate the integral gain,

$$\begin{matrix}{K}_{1} = \vert z \vert \cdot {K}_{p} \\ = .1 ( 4.26 ) \\ = .426\end{matrix}$$

### Simulation Results:

A computer simulation showing the exemplary system response to a unit amplitude step signal input is shown in FIG. 4. The plant is the true 8^{th} order system, the PI controller gains are as calculated in Steps 6 and 7.

While the present invention has been particularly shown and described with reference to the preferred mode as illustrated in the drawings, it will be understood by one skilled in the art that various changes in detail may be effected therein without departing from the spirit and scope of the invention as defined by the claims.

It is also to be understood that the invention can be generalized and applied to any HVAC or HVACR system. A specific example of such a system is the Carrier Corporation 3V system. Also, while exemplary embodiments of the invention typically control a damper component, the invention is suitable to other lag dominated HVAC/HVACR PI control scenarios including setting the Proportional Integral (PI) gains in a variety of lag-dominated HVACR System applications.

We Claim:

1. A method to determine and apply PI gain constants to an HVAC PI controller when used on a lag dominated HVAC component comprising the steps of:
recording an open loop HVAC component dynamic response;
fitting the HVAC component dynamic response to a transfer function model representative of a first order lag dominated process;
calculating the PI gain constants from the model;
entering the calculated PI gain constants into a PI control algorithm; and
running the PI control algorithm on the HVAC PI controller to control the HVAC component.

2. The method of claim I wherein the steps of fitting the HVAC component dynamic response, calculating the PI gain constants, and entering the calculated PI gain constants are performed automatically by a computer.

3. The method of claim 2 wherein the HVAC PI controller comprises the computer.

4. The method of claim 1 wherein recording an open loop HVAC component dynamic step response further comprises recording an open loop HVAC component dynamic step response of an HVAC damper cycling through its range.

5. The method of claim 4 wherein recording an open loop HVAC component dynamic step response is done during the commissioning of the HVAC component.

6. The method of claim I wherein fitting the HVAC component dynamic response to a transfer function model comprises fitting to a first order transfer function with a pure time delay.

7. The method of claim 1 wherein calculating the PI gain constants from the model comprises calculating PI gain constants selected from the group consisting of K₁, and Kₚ.

8. The method of claim 1 wherein fitting the HVAC component dynamic response to a transfer function model comprises fitting by use of an identification method.

9. The method of claim 8 wherein the identification method is a least squares method or similar.

10. The method of claim 1 wherein running the PI control algorithm on the HVAC PI controller comprises running the PI control algorithm on an HVAC PI zone controller or an HVAC PI bypass controller.

11. The method of claim 1 wherein calculating the PI gain constants from the model comprises calculating the PI gain constants based on the model parameters and a desired damping ratio using a Root Locus method.

12. The method of claim 1 wherein calculating the PI gain constants from the model further comprises removing a transcendental term using a Pade approximation.

13. The method of claim 1 wherein recording an open loop HVAC component dynamic response comprises recording an open loop HVAC component dynamic response of a lag dominated HVAC or HVACR system.

14. An HVAC system comprising:
an HVAC system component;
an HVAC system component controller electrically connected to the HVAC system component to control the operation of the HVAC system component; and
a PI algorithm, the PI algorithm running on a microcomputer in the HVAC system component controller, the PI algorithm having PI gain constants, wherein the HVAC system component controller operates a closed PI loop and the PI algorithm uses PI gain constants calculated from the open loop transfer function of the HVAC system component.

15. The HVAC system of claim 14 wherein the HVAC system component is part of a lag dominated HVAC or HVACR system.

16. The HVAC system of claim 14 wherein the PI gain constants are automatically calculated by a computer based on a set of data comprising open loop dynamic measurements of the HVAC system component.

17. The HVAC system of claim 16 wherein the computer is a part of the HVAC system component controller.

18. The HVAC system of claim 14 wherein the HVAC system component is a damper.

19. The HVAC system of claim 14 wherein the damper is a zone damper or a bypass damper.

20. The HVAC system of claim 14 wherein the HVAC system component controller is a zone controller or a bypass controller.

21. The HVAC system of claim 14 wherein the system is a Carrier Corporation 3V system.
